(19) United States
(12) Patent Application Publication
(10) Pub. No.: US 2023/0137775 A1
(43) Pub. Date: May 4, 2023

(54) BASE STATION, WIRELESS COMMUNICATION SYSTEM, AND WIRELESS COMMUNICATION METHOD

(71) Applicant: NIPPON TELEGRAPH AND TELEPHONE CORPORATION, Tokyo (JP)

(72) Inventors: Naotaka SHIBATA, Musashino-shi, Tokyo (JP); Hirotaka UJIKAWA, Musashino-shi, Tokyo (JP)

(73) Assignee: NIPPON TELEGRAPH AND TELEPHONE CORPORATION, Tokyo (JP)

(21) Appl. No.: 17/913,197

(22) PCT Filed: Mar. 27, 2020
(86) PCT No.: PCT/JP2020/014280

§ 371 Date: Sep. 21, 2022

(51) Int. Cl. H04W 76/10; H04L 5/00

(52) U.S. Cl. CPC H04W 76/10; H04L 5/0053; H04W 80/06

(57) ABSTRACT

A base station which performs relaying between a wireless terminal and a server, the wireless terminal and the server establishing connection with each other, includes a request detection unit which detects a connection establishment request transmitted to the server by the wireless terminal, a response detection unit which detects an acknowledgment transmitted to the wireless terminal by the server on the basis of the connection establishment request detected by the request detection unit, and a band allocation unit which, if the response detection unit detects the acknowledgment, performs allocation so as to expand a band over which the wireless terminal is capable of transmission to the server, regardless of presence or absence of a buffer amount notification from the wireless terminal.

### TECHNICAL FIELD

The present invention relates to a base station, a wireless communication system, and a wireless communication method.

### BACKGROUND ART

Some of wireless communication systems establish connection by using TCP (Transmission Control Protocol) and implement highly reliable communication between a wireless terminal (client) and a server.

Examples of a wireless terminal used in the such wireless communication systems include a cellular phone and a smartphone. For example, the wireless terminal communicates with components such as a content server which provides content via a base station.

### CITATION LIST

### Non-Patent Literature

Non-Patent Literature 1: Takeshita, Takafumi and three others, “masutaringu TCP/IP nyumon hen” (mastering TCP/IP: elementary level), 5th ed., Ohmsha, Ltd., Feb. 25, 2012, p. 230-256

### SUMMARY OF THE INVENTION

### Technical Problem

For example, in TCP communication, an algorithm called slow start is used at the start of communication in order to prevent a client, such as a wireless terminal, from transmitting massive data to a server from the beginning to cause an excess over the capacity of a network.

Slow start has parameters, such as a congestion window (CW) and a slow start threshold (SST).

The amount of data to be transmitted by a wireless terminal depends on a CW. For the wireless terminal, an initial value for the CW is set to be small. Upon receipt of a positive acknowledgment (ACK) from a server, the wireless terminal exponentially increases a value of the CW.

In TCP communication, a wireless terminal can only transmit data, the amount of which is dependent on a CW, until the wireless terminal receives an ACK. A round trip time (RTT) thus largely affects throughput.

A base station allocates communication resources (a band) for a wireless terminal on the basis of a buffer amount notification transmitted by the wireless terminal. For this reason, the wireless terminal may suffer from an increase in delay and a reduction in throughput, depending on a band allocated by the base station and a time period taken for the base station to allocate the band.

An object of the present invention is to provide a base station, a wireless communication system, and a wireless communication method capable of enhancing throughput of a wireless terminal even when the wireless terminal establishes connection with a server to perform communication.

### Means for Solving the Problem

A base station according to one aspect of the present invention is a base station which performs relaying between a wireless terminal and a server, the wireless terminal and the server establishing connection with each other, including a request detection unit which detects a connection establishment request transmitted to the server by the wireless terminal, a response detection unit which detects an acknowledgment transmitted to the wireless terminal by the server on the basis of the connection establishment request detected by the request detection unit, and a band allocation unit which, if the response detection unit detects the acknowledgment, performs allocation so as to expand a band over which the wireless terminal is capable of transmission to the server, regardless of presence or absence of a buffer amount notification from the wireless terminal.

A wireless communication system according to one aspect of the present invention is a wireless communication system including a server and a base station which performs relaying between a wireless terminal and the server, the wireless terminal and the server establishing connection with each other, wherein the base station includes a request detection unit which detects a connection establishment request transmitted to the server by the wireless terminal, a response detection unit which detects an acknowledgment transmitted to the wireless terminal by the server on the basis of the connection establishment request detected by the request detection unit, and a band allocation unit which, if the response detection unit detects the acknowledgment, performs allocation so as to expand a band over which the wireless terminal is capable of transmission to the server, regardless of presence or absence of a buffer amount notification from the wireless terminal.

A wireless communication method according to one aspect of the present invention is a wireless communication method for performing relaying between a wireless terminal and a server, the wireless terminal and the server establishing connection with each other, including a request detection step of detecting a connection establishment request transmitted to the server by the wireless terminal, a response detection step of detecting an acknowledgment transmitted to the wireless terminal by the server on the basis of the detected connection establishment request, and a band allocation step of, if the acknowledgment is detected, performing allocation so as to expand a band over which the wireless terminal is capable of transmission to the server, regardless of presence or absence of a buffer amount notification from the wireless terminal.

### Effects of the Invention

According to the present invention, it is possible to enhance throughput of a wireless terminal even when the wireless terminal establishes connection with a server to perform communication.

### BRIEF DESCRIPTION OF DRAWINGS

FIG. 1 is a diagram showing an example of a configuration of a wireless communication system.

FIG. 2 is a functional block diagram showing an outline of functions which a base station has.

FIG. 3 is a sequence chart showing an example of operation of the wireless communication system including the base station.

FIG. 4 is a functional block diagram showing an outline of functions which a base station according to one embodiment has.

FIG. 5 is a sequence chart showing an example of operation of a wireless communication system including the base station according to the one embodiment.

FIG. 6 is a diagram showing an example of a hardware configuration of the base station according to the one embodiment.

### DESCRIPTION OF EMBODIMENTS

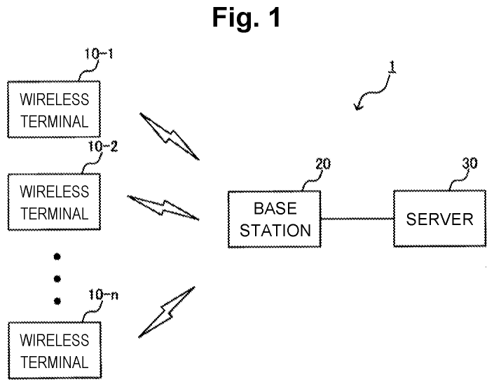

A background against which the present invention has been made will be described first. FIG. 1 is a diagram showing an example of a configuration of a wireless communication system 1. As shown in FIG. 1, the wireless communication system 1 has, for example, n wireless terminals 10-1 to 10-n, a base station 20, and a server 30. Note that the numbers of base stations 20 and servers 30 are not limited.

The wireless terminals 10-1 to 10-n are each, for example, a cellular phone or a smartphone, and establish, for example, TCP connection with the server 30 via the base station 20 and perform communication. Note that if any of a plurality of components, such as the wireless terminals 10-1 to 10-n, is not specified, each wireless terminal will simply be referred to as a wireless terminal 10 or the like hereinafter.

The base station 20 is connected to the server 30 via a wired or wireless network and performs wireless communication with each of the wireless terminals 10-1 to 10-n. The server 30 is, for example, a content server. Note that the server 30 only needs to be a device which establishes connection with the wireless terminal 10 and performs communication and may be, for example, a PC (personal computer) or the like.

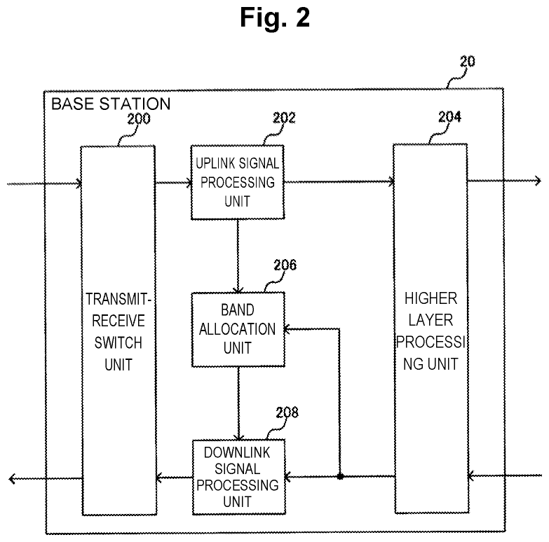

FIG. 2 is a functional block diagram showing an outline of functions which the base station 20 has. As shown in FIG. 2, the base station 20 has, for example, a transmit-receive switch unit 200, an uplink signal processing unit 202, a higher layer processing unit 204, a band allocation unit 206, and a downlink signal processing unit 208.

The transmit-receive switch unit 200 has a function as a wireless communication unit which performs wireless communication with the wireless terminal 10 and switches between uplink communication and downlink communication with the wireless terminal 10. For example, the transmit-receive switch unit 200 receives an uplink signal which is transmitted by the wireless terminal 10 and outputs the uplink signal to the uplink signal processing unit 202. The transmit-receive switch unit 200 also transmits a downlink signal which is processed by the downlink signal processing unit 208 to the wireless terminal 10.

The uplink signal processing unit 202 performs predetermined processing on an uplink signal which is input from the transmit-receive switch unit 200 and outputs the processed uplink signal to the higher layer processing unit 204. The uplink signal processing unit 202 also outputs buffer information indicating a capacity of a transmit-receive buffer which each wireless terminal 10 includes to the band allocation unit 206. Note that the buffer information of the wireless terminal 10 is transmitted as an uplink signal.

The higher layer processing unit 204 has a function as a network interface which performs, for example, U-plane wireless protocol processing and performs uplink communication and downlink communication with the server 30.

For example, the higher layer processing unit 204 performs processing (higher layer processing), such as MAC (Media Access Control) layer processing and RLC/PDCP (Radio Link Control/Packet Data Convergence Protocol) layer, on an uplink signal which is processed by the uplink signal processing unit 202 and transmits the processed uplink signal to the server 30.

The higher layer processing unit 204 receives a downlink signal which is transmitted by the server 30, performs the higher layer processing on the downlink signal, and outputs the downlink signal to the band allocation unit 206 and the downlink signal processing unit 208.

The band allocation unit 206 allocates respective communication resource amounts (bands) for the wireless terminals 10 on the basis of pieces of buffer information which are input from the uplink signal processing unit 202 and a downlink signal subjected to the higher layer processing by the higher layer processing unit 204 and outputs pieces of band information indicating the allocated bands to the downlink signal processing unit 208.

The downlink signal processing unit 208 performs signal processing such that a downlink signal subjected to the higher layer processing by the higher layer processing unit 204 is arranged in bands which are allocated by the band allocation unit 206 and outputs the processed downlink signal to the transmit-receive switch unit 200.

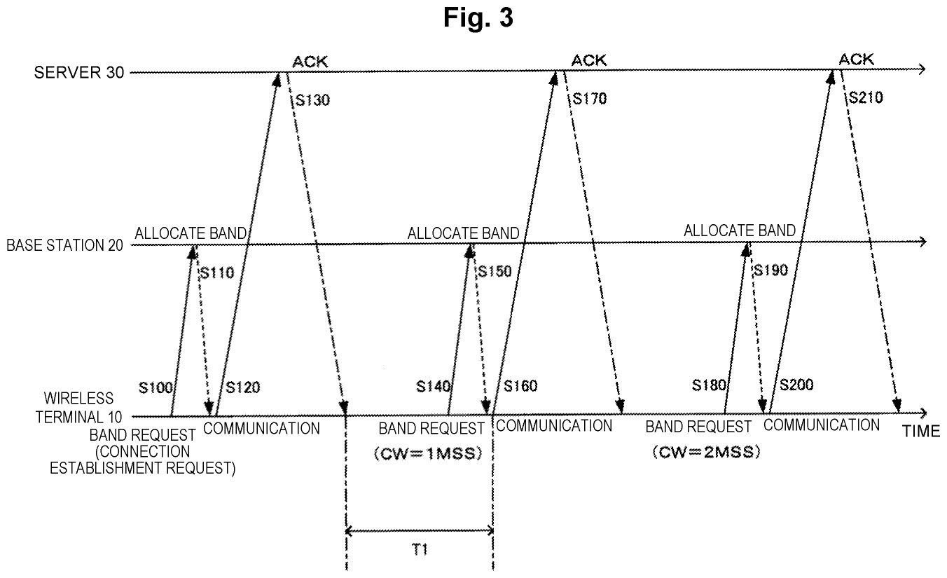

FIG. 3 is a sequence chart showing an example of operation of the wireless communication system 1 including the base station 20. As shown in FIG. 3, the wireless terminal 10 first requests a band for connection by the base station 20 in order to request establishment of connection with the server 30 (S100).

The base station 20 makes a response of intent to allocate a band for connection to the wireless terminal 10(S110).

The wireless terminal 10 transmits a SYN packet for establishing TCP connection by using a band which is allocated by the base station 20 to the server 30 via the base station 20 (S120).

The server 30 transmits a response (ACK) to the SYN packet transmitted from the wireless terminal 10 to the wireless terminal 10 via the base station 20 (S130).

Note that a time period from when the wireless terminal 10 transmits a SYN packet to the server 30 to when the wireless terminal 10 receives a response (ACK) from the server 30 is a round trip time (RTT).

The wireless terminal 10 sets a congestion window (CW) to 1 MSS (Maximum Segment Size) and tries to start communication with the server 30. Even though the wireless terminal 10 has created data to be transmitted, no band for connection has yet been allocated. For this reason, the wireless terminal 10 temporarily stores the data in the buffer and makes a band request (buffer amount notification) based on an amount by which the buffer is occupied to the base station 20 (S140).

Note that the congestion window (CW) is a value which is passed in a connection establishment request and a response thereto and is expressed as n×MSS. As to an initial value for the congestion window (CW), although n is set at 1 in FIG. 3, n is defined as 4 in RFC 2581, and n is defined as 10 in RFC 6928.

The base station 20 makes a response of intent to allocate a band for connection to the wireless terminal 10 (S150).

The wireless terminal 10 transmits the data to the server 30 via the base station 20 by using an allocated band (S160). Here, let T1 be a time period from when the wireless terminal 10 receives a response (ACK) from the server 30 to when the wireless terminal 10 transmits data to the server 30.

The server 30 transmits a response (ACK) to the data transmitted with the CW of 1 MSS from the wireless terminal 10 to the wireless terminal 10 via the base station 20 (S170).

The wireless terminal 10 then sets the CW to 2 MSS and requests a band for connection by the base station 20 (S180).

The base station 20 makes a response of intent to allocate a band for connection to the wireless terminal 10 (S190).

The wireless terminal 10 transmits data to the server 30 via the base station 20 by using an allocated band (S200).

The server 30 transmits a response (ACK) to the data transmitted with the CW of 2 MSS from the wireless terminal 10 to the wireless terminal 10 via the base station 20 (S210).

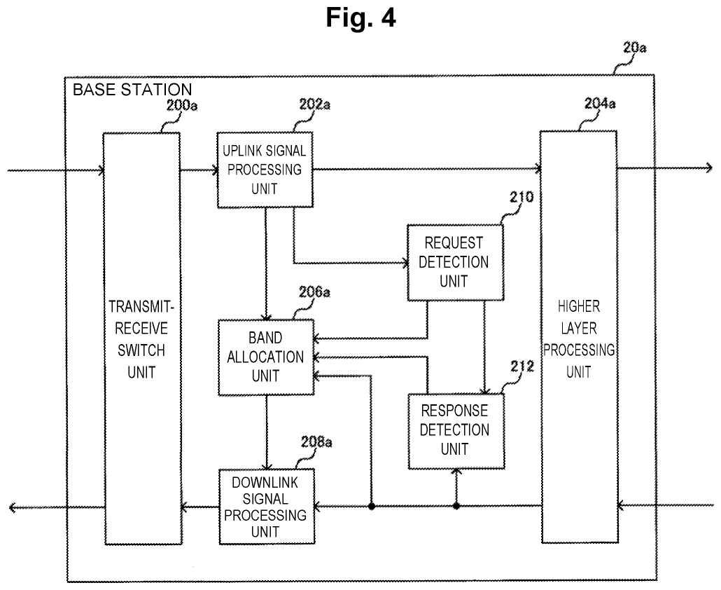

Next, a base station 20a according to one embodiment will be described. FIG. 4 is a functional block diagram showing an outline of functions which the base station 20a according to the one embodiment has. The base station 20a is replaced by the base station 20 shown in FIG. 1 to constitute a wireless communication system 1. The base station 20a performs relaying between a wireless terminal 10 and a server 30 which establish connection with each other by, for example, TCP.

As shown in FIG. 4, the base station 20a has a transmit-receive switch unit 200a, an uplink signal processing unit 202a, a request detection unit 210, a higher layer processing unit 204a, a response detection unit 212, a band allocation unit 206a, and a downlink signal processing unit 208a.

The transmit-receive switch unit 200a has a function as a wireless communication unit which performs wireless communication with the wireless terminal 10 and switches between uplink communication and downlink communication with the wireless terminal 10. For example, the transmit-receive switch unit 200a receives an uplink signal which is transmitted by the wireless terminal 10 and outputs the uplink signal to the uplink signal processing unit 202a. The transmit-receive switch unit 200a also transmits a downlink signal which is processed by the downlink signal processing unit 208a to the wireless terminal 10.

The uplink signal processing unit 202a, for example, performs predetermined processing on an uplink signal which is input from the transmit-receive switch unit 200a and outputs the processed uplink signal to the request detection unit 210 and the higher layer processing unit 204a. The uplink signal processing unit 202a also outputs buffer information indicating a capacity of a transmit-receive buffer which each wireless terminal 10 includes to the band allocation unit 206. Note that the buffer information of the wireless terminal 10 is transmitted as an uplink signal.

The request detection unit 210 detects a connection establishment request which is transmitted to the server 30 by the wireless terminal 10 on the basis of, for example, a processed uplink signal which is input from the uplink signal processing unit 202a and outputs information indicating the transmission of the connection establishment request to the server 30 by the wireless terminal 10 and a destination address to the band allocation unit 206a and the response detection unit 212.

For example, the request detection unit 210 detects a SYN packet for establishing TCP connection which is transmitted to the server 30 by the wireless terminal 10 and outputs information indicating the detection and a communication partner (transmission information and a destination address) to the band allocation unit 206a and the response detection unit 212.

The higher layer processing unit 204a has a function as a network interface which performs, for example, U-plane wireless protocol processing and performs uplink communication and downlink communication with the server 30.

For example, the higher layer processing unit 204a performs processing (higher layer processing), such as MAC layer processing and RLC/PDCP layer, on an uplink signal which is processed by the uplink signal processing unit 202a and transmits the processed uplink signal to the server 30.

The higher layer processing unit 204a receives a downlink signal which is transmitted by the server 30, performs the higher layer processing on the downlink signal, and outputs the downlink signal to the response detection unit 212, the band allocation unit 206a, and the downlink signal processing unit 208a.

The response detection unit 212 detects an acknowledgment (ACK) which is transmitted to the wireless terminal 10 by the server 30 on the basis of, for example, information which is input from the request detection unit 210 and a downlink signal subjected to the higher layer processing by the higher layer processing unit 204a. The response detection unit 212 outputs information indicating the transmission of the acknowledgment (ACK) to the wireless terminal 10 by the server 30, a predetermined instruction (to be described later), and the like to the band allocation unit 206a.

Note that, after information is input from the request detection unit 210, the response detection unit 212 waits for a fixed time period for an acknowledgment (ACK) which is a communication opposite in transmission information and destination address to an uplink signal. The fixed time period is set to a length equal to or more than a time period (a retransmission time-out time period) taken for a transmitting side (the wireless terminal 10) to retransmit data.

For example, if the response detection unit 212 detects an acknowledgment (ACK) within the fixed time period, since a CW is expected to be increased in later TCP communication, the response detection unit 212 instructs the band allocation unit 206a to allocate a band wider than last time.

The band allocation unit 206a allocates respective communication resource amounts (bands) for the wireless terminals 10 on the basis of pieces of buffer information which are input from the uplink signal processing unit 202a, a downlink signal subjected to the higher layer processing by the higher layer processing unit 204a, information which is input from the request detection unit 210, information which is input from the response detection unit 212, and the like and outputs pieces of band information indicating the allocated bands to the downlink signal processing unit 208a.

For example, if the response detection unit 212 detects an acknowledgment (ACK), the band allocation unit 206a performs allocation so as to expand a band over which the wireless terminal 10 is capable of transmission to the server 30, regardless of presence or absence of a buffer amount notification to be transmitted by the wireless terminal 10.

In the presence of a buffer amount notification transmitted by the wireless terminal 10, the band allocation unit 206a may allocate a band over which the wireless terminal 10 is capable of transmission to the server 30, regardless of the magnitude of a buffer amount in question. That is, the band allocation unit 206a may be configured to ignore a buffer amount notification in question if the wireless terminal 10 transmits the buffer amount notification.

In normal TCP communication, a congestion window (CW) increases exponentially. In contrast, the band allocation unit 206a performs band allocation, for example, on the assumption that a congestion window (CW) is twice wider than last time. Note that a band to be allocated by the band allocation unit 206a is not limited to an amount twice a width of a most recently allocated band if the response detection unit 212 detects an acknowledgment.

For example, the band allocation unit 206a may allocate a band on the assumption that the congestion window (CW) increases to a maximum value for a standard. Alternatively, the band allocation unit 206a may perform band allocation for the congestion window (CW) having an initial value after a SYN packet for establishing TCP connection is detected, and a first ACK packet is received.

The band allocation unit 206a may determine the initial value on the basis of the fact that n=4 in RFC 2581, the fact that n=10 in RFC 6928, or the like. Alternatively, the band allocation unit 206a may monitor uplink traffic thus far, learn how wide a band is needed as an initial value, and allocate a band. For example, if the response detection unit 212 detects an acknowledgment, the band allocation unit 206a may perform allocation so as to expand a band on the basis of statistics obtained by learning traffic amounts after past acknowledgment detection by the response detection unit 212.

The downlink signal processing unit 208a performs signal processing such that a downlink signal subjected to the higher layer processing by the higher layer processing unit 204a is arranged in bands which are allocated by the band allocation unit 206a and outputs the processed downlink signal to the transmit-receive switch unit 200a.

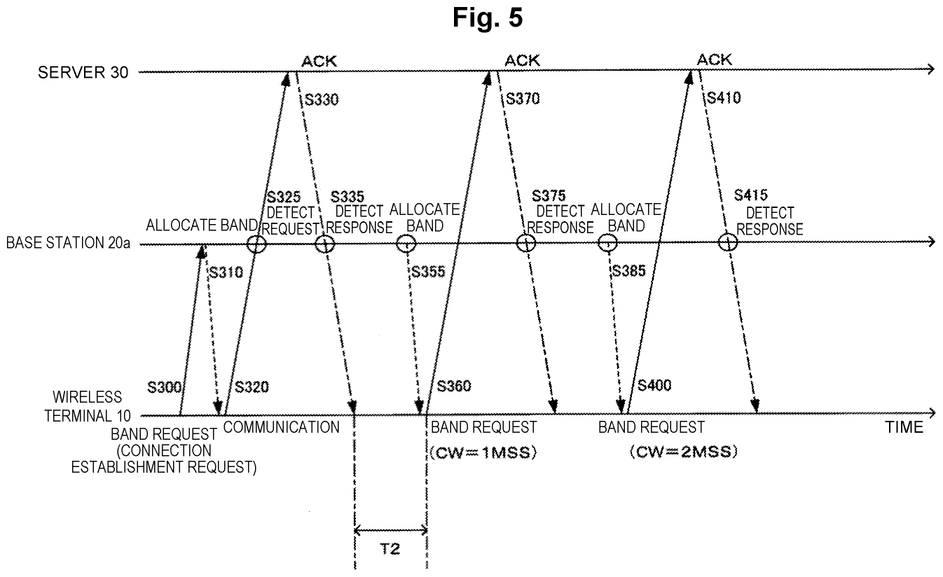

An example of operation of the wireless communication system 1 including the base station 20a will be described. FIG. 5 is a sequence chart showing the example of the operation of the wireless communication system 1 including the base station 20a according to the one embodiment. As shown in FIG. 5, the wireless terminal 10 first requests a band for connection by the base station 20a in order to request establishment of connection with the server 30 (S300).

The base station 20a makes a response of intent to allocate a band for connection to the wireless terminal 10 (S310).

The wireless terminal 10 transmits a SYN packet for establishing TCP connection by using a band which is allocated by the base station 20 to the server 30 via the base station 20a (S320).

At this time, in the base station 20a, the request detection unit 210 detects a connection establishment request which is transmitted to the server 30 by the wireless terminal 10 (S325).

The server 30 transmits a response (ACK) to the SYN packet transmitted from the wireless terminal 10 to the wireless terminal 10 via the base station 20a (S330).

At this time, in the base station 20a, the response detection unit 212 detects the acknowledgment (ACK) transmitted to the wireless terminal 10 by the server 30 on the basis of the connection establishment request detected by the request detection unit 210 (S335).

Note that a time period from when the wireless terminal 10 transmits a SYN packet to the server 30 to when the wireless terminal 10 receives a response (ACK) from the server 30 is a round trip time (RTT).

If the response detection unit 212 detects the acknowledgment (ACK), the base station 20a performs allocation so as to expand a band over which the wireless terminal 10 is capable of transmission to the server 30, regardless of presence or absence of a buffer amount notification to be transmitted by the wireless terminal 10 (S355).

Even without the wireless terminal 10 requesting band allocation by the base station 20a, the base station 20a expands and allocates the band in the process in S355. Thus, the wireless terminal 10 sets the CW to, for example, 1 MSS and transmits data to the server 30 via the base station 20a (S360).

Here, let T2 be a time period from when the wireless terminal 10 receives a response (ACK) from the server 30 to when the wireless terminal 10 transmits data to the server 30. The time period T2 shown in FIG. 5 is shorter than the time period T1 shown in FIG. 3. This is because a time period taken for the wireless terminal 10 to request a band by the base station 20a is unnecessary.

The server 30 transmits a response (ACK) to the data transmitted with the CW of 1 MSS from the wireless terminal 10 to the wireless terminal 10 via the base station 20a (S370).

At this time, in the base station 20a, the response detection unit 212 detects the acknowledgment (ACK) transmitted to the wireless terminal 10 by the server 30 on the basis of a connection establishment request which is detected by the request detection unit 210 (S375).

If the response detection unit 212 detects the acknowledgment (ACK), the base station 20a performs allocation so as to expand the band, over which the wireless terminal 10 is capable of transmission to the server 30, regardless of presence or absence of a buffer amount notification to be transmitted by the wireless terminal 10 (S385).

Even without the wireless terminal 10 requesting band allocation by the base station 20a, the base station 20a expands and allocates the band in the process in S385. Thus, the wireless terminal 10 sets the CW to, for example, 2 MSS and transmits data to the server 30 via the base station 20a (S400).

The server 30 transmits a response (ACK) to the data transmitted with the CW of 2 MSS from the wireless terminal 10 to the wireless terminal 10 via the base station 20a (S410).

At this time, in the base station 20a, the response detection unit 212 detects the acknowledgment (ACK) transmitted to the wireless terminal 10 by the server 30 on the basis of a connection establishment request which is detected by the request detection unit 210 (S415) and continues predetermined communication.

As described above, if the base station 20a detects a TCP-based connection establishment request which is transmitted by the wireless terminal 10 and detects an acknowledgment which is transmitted by the server 30, the base station 20a performs allocation so as to expand a band over which the wireless terminal 10 is capable of transmission, regardless of presence or absence of a buffer amount notification to be transmitted by the wireless terminal 10. For this reason, the base station 20a can reduce a time period required for band allocation and enhance throughput of the wireless terminal 10.

Note that a part or the whole of each of functions which the wireless terminal 10, the base station 20, the base station 20a, and the server 30 have may be implemented by hardware or may be implemented as a program to be executed by a processor, such as a CPU.

That is, the wireless communication system 1 according to the present invention can be implemented by using a computer and a program, and the program can be recorded on a storage medium or can be provided through a network.

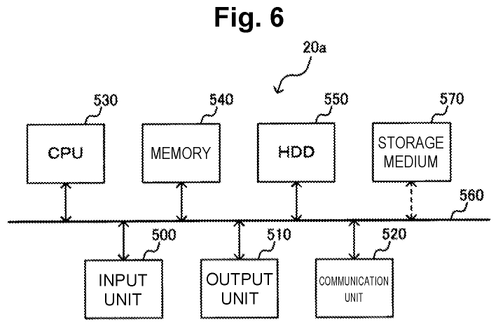

FIG. 6 is a diagram showing an example of a hardware configuration of the base station 20a according to the one embodiment. As shown in FIG. 6, for example, an input unit 500, an output unit 510, a communication unit 520, a CPU 530, a memory 540, and an HDD 550 are connected via a bus 560, and the base station 20a has functions as a computer. The base station 20a is configured to be capable of inputting and outputting data from and to a storage medium 570.

The input unit 500 is, for example, a keyboard or a mouse. The output unit 510 is, for example, a display device, such as a display. The communication unit 520 is, for example, a wireless or wired network interface.

The CPU 530 controls the units constituting the base station 20a and performs the above-described processing. The memory 540 and the HDD 550 store data. The storage medium 570 is configured to be capable of storing, e.g., a wireless communication program which causes execution of the functions that the base station 20a has. Note that architecture of the base station 20a is not limited to the example shown in FIG. 6. The wireless terminal 10 and the server 30 may have the same configurations as the base station 20a.

### REFERENCE SIGNS LIST

1 Wireless communication system
10-1 to 10-n Wireless terminal
20, 20a Base station
30 Server
200, 200a Transmit-receive switch unit
202, 202a Uplink signal processing unit
204, 204a Higher layer processing unit
206, 206a Band allocation unit
208, 208a Downlink signal processing unit
210 Request detection unit
212 Response detection unit
500 Input unit
510 Output unit
520 Communication unit
530 CPU
540 Memory
550 HDD
560 Bus
570 Storage medium

1. A base station which performs relaying between a wireless terminal and a server, the wireless terminal and the server establishing connection with each other, comprising:
a processor; and
a storage medium having computer program instructions stored thereon, when executed by the processor, perform to:
detects a connection establishment request transmitted to the server by the wireless terminal;
detects an acknowledgment transmitted to the wireless terminal by the server on the basis of the connection establishment request; and
if the response detection unit detects the acknowledgment, performs allocation so as to expand a band over which the wireless terminal is capable of transmission to the server, regardless of presence or absence of a buffer amount notification from the wireless terminal.

2. The base station according to claim 1, wherein the computer program instructions further perform to detects a TCP-based connection establishment request transmitted to the server by the wireless terminal.

3. The base station according to claim 1, wherein the computer program instructions further perform to allocates a band twice a width of a most recently allocated band if the response detection unit detects the acknowledgment.

4. The base station according to claim 1, wherein the computer program instructions further performs allocation so as to expand the band on the basis of statistics obtained by learning a traffic amount after past detection of the acknowledgment by the response detection unit if the response detection unit detects the acknowledgment.

5. A wireless communication system comprising a server and a base station which performs relaying between a wireless terminal and the server, the wireless terminal and the server establishing connection with each other,
wherein the base station comprises
a request detection unit which detects a connection establishment request transmitted to the server by the wireless terminal,
a response detection unit which detects an acknowledgment transmitted to the wireless terminal by the server on the basis of the connection establishment request detected by the request detection unit, and
a band allocation unit which, if the response detection unit detects the acknowledgment, performs allocation so as to expand a band over which the wireless terminal is capable of transmission to the server, regardless of presence or absence of a buffer amount notification from the wireless terminal.

6. The wireless communication system according to claim 5, wherein
the request detection unit
detects a TCP-based connection establishment request transmitted to the server by the wireless terminal.

7. A wireless communication method for performing relaying between a wireless terminal and a server, the wireless terminal and the server establishing connection with each other, comprising:
a request detection step of detecting a connection establishment request transmitted to the server by the wireless terminal;
a response detection step of detecting an acknowledgment transmitted to the wireless terminal by the server on the basis of the detected connection establishment request; and
a band allocation step of, if the acknowledgment is detected, performing allocation so as to expand a band over which the wireless terminal is capable of transmission to the server, regardless of presence or absence of a buffer amount notification from the wireless terminal.

8. The wireless communication method according to claim 7, wherein
the request detection step comprises
detecting a TCP-based connection establishment request transmitted to the server by the wireless terminal.
